(19) United States
(12) Patent Application Publication
(10) Pub. No.: US 2026/0291797 A1
(43) Pub. Date: Sep. 24, 2026

(54) METHOD AND APPARATUS FOR TRANSMITTING AND RECEIVING REFERENCE SIGNALS IN A WIRELESS COMMUNICATION

(71) Applicant: Samsung Electronics Co., Ltd., Suwon-si, Gyeonggi-do (KR)

(72) Inventors: Nan JIANG, Beijing (CN); Yu XIAO, Beijing (CN); Yupeng CUI, Beijing (CN); Bowen YANG, Beijing (CN); Di SU, Beijing (CN); Chen QIAN, Beijing (CN)

(21) Appl. No.: 19/475,635

(22) PCT Filed: Aug. 2, 2024
(86) PCT No.: PCT/KR2024/011395

§ 371 Date: Oct. 15, 2025

(30) Foreign Application Priority Data
Aug. 7, 2023 (CN) 202310988883.0

(51) Int. Cl. H04L 27/26; H04L 5/00

(52) U.S. Cl. CPC H04L 27/2613; H04L 5/0048

(57) ABSTRACT

The disclosure relates to a 5G or 6G communication system for supporting a higher data transmission rate. The present disclosure provides a method and apparatus for transmitting and receiving reference signals in a wireless communication network. The method includes: receiving configuration information for reference signals; determining, according to the configuration information, an association relationship between a plurality of antenna ports of a first node and a plurality of reference signal ports indicated in the configuration information; and based on the determined association relationship, transmitting the reference signals via the plurality of antenna ports corresponding to the plurality of reference signal ports indicated by the configuration information; wherein, the association relationship indicates that each reference signal port indicated by the configuration information corresponds to one antenna port of the first node.

### TECHNICAL FIELD

The present application relates to a field of wireless communication technologies, and more particularly, to a method and apparatus for transmitting and receiving reference signals in a wireless communication network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to controlling a plurality of reference signal ports.

### Solution to Problem

According to an embodiment of the present disclosure, there is provided a method performed by a first node in a communication system. The method includes: receiving configuration information for reference signals; determining, according to the configuration information, an association relationship between a plurality of antenna ports of the first node and a plurality of reference signal ports indicated in the configuration information; and based on the determined association relationship, transmitting the reference signals via the plurality of antenna ports corresponding to the plurality of reference signal ports indicated by the configuration information; wherein, the association relationship indicates that each reference signal port indicated by the configuration information corresponds to one antenna port of the first node.

Optionally, determining, according to the configuration information, the association relationship between the plurality of antenna ports of the first node and the plurality of reference signal ports indicated in the configuration information, comprises: each antenna port of the first node being associated with a different reference signal port indicated in the configuration information, and the association relationship between the plurality of the antenna ports and the plurality of the reference signal ports being kept consistent in a same cell

Optionally, the configuration information comprises an index set, each index in the index set is used for identifying one different antenna port of the first node, and the index is associated with one different reference signal port; determining, according to the configuration information, the association relationship between the plurality of antenna ports of the first node and the plurality of reference signal ports indicated in the configuration information, comprises: determining, according to each index in the index set in the configuration information, the association relationship between an antenna port identified by the index and a reference signal port associated with the index.

Optionally, the index is reported by the first node; or the index is configured by a second node for an antenna port of the first node, and each index is associated with one different antenna port of the first node.

determining, according to the configuration information, the association relationship between the plurality of antenna ports of the first node and the plurality of reference signal ports indicated in the configuration information, comprises: based on ordering of the plurality of antenna ports of the first node and an order of symbols corresponding to the reference signal ports comprised in the plurality of reference signal resource sets indicated by the configuration information, determining the association relationship between each antenna port in the plurality of antenna ports and one reference signal port.

Optionally, the configuration information further comprises an update flag, wherein, the update flag indicates whether to update the ordering of the plurality of antenna ports of the first node.

Optionally, when it is determined based on the ordering of the plurality of antenna ports of the first node and the plurality of reference signal resource sets indicated in the configuration information that a number of the plurality of reference signal ports is less than or equal to a number of the plurality of antenna ports, making the plurality of reference signal ports correspond to the antenna ports in the ordering of the plurality of antenna ports in sequence according to the order of symbols corresponding to the reference signal ports comprised in the plurality of reference signal resource sets.

Optionally, the ordering of the plurality of antenna ports of the first node is determined based on information for indicating the order of symbols corresponding to the reference signal ports comprised in the plurality of reference signal resource sets in the configuration information.

Optionally, the information for a first reference signal resource set in the configuration information comprises indication information; determining, according to the configuration information, the association relationship between the plurality of antenna ports of the first node and the plurality of reference signal ports indicated in the configuration information, comprises: determining, according to the association relationship between reference signal ports in a second reference signal resource set and antenna ports of the first node indicated by the indication information, the association relationship between reference signal ports comprised in the first reference signal resource set and the antenna ports of the first node.

Optionally, the indication information is an ID of the second reference signal resource set.

Optionally, information for a reference signal resource set associated with a first antenna switching method in the configuration information comprises identity information for identifying a plurality of reference signal resource sets associated with a second antenna switching method; determining, according to the configuration information, the association relationship between the plurality of antenna ports of the first node and the plurality of reference signal ports indicated in the configuration information, comprises: determining, according to the association relationship between the antenna ports of the first node and the reference signal ports that are comprised in a plurality of reference signal resource sets associated with the second antenna switching method identified by the identity information, the association relationship between reference signal ports comprised in the reference signal source set associated with the first antenna switching method and the antenna ports of the first node.

According to another embodiment of the present disclosure, there is provided a method performed by a second node in a communication system. The method includes: transmitting configuration information for reference signals; determining an association relationship between a plurality of antenna ports of a first node and a plurality of reference signal ports indicated in the configuration information; receiving the reference signals transmitted by the first node via the plurality of antenna ports corresponding to the plurality of reference signal ports indicated by the configuration information; wherein, the association relationship indicates that each reference signal port indicated by the configuration information corresponds to one antenna port of the first node.

Optionally, the configuration information comprises an index set, each index in the index set is used for identifying one different antenna port of the first node, and the index is associated with one different reference signal port.

Optionally, the index is reported by the first node; or the index is configured by a second node for an antenna port of the first node, and each index is associated with one different antenna port of the first node.

Optionally, the configuration information further comprises an update flag, wherein, the update flag indicates whether to update the ordering of the plurality of antenna ports of the first node.

Optionally, the configuration information further comprises information for indicating an order of symbols corresponding to the reference signal ports comprised in a plurality of reference signal resource sets.

Optionally, the configuration information comprises information for a first reference signal resource set, wherein, the information for the first reference signal resource set comprises indication information; and wherein, the indication information indicates an association relationship between reference signal ports comprised in a second reference signal resource set and antenna ports of the first node.

Optionally, the indication information is an ID of the second reference signal resource set.

Optionally, the configuration information comprises information for a reference signal resource set associated with a first antenna switching method, wherein, the information for the reference signal resource set associated with the first antenna switching method comprises identity information for identifying a plurality of reference signal resource sets associated with a second antenna switching method; and wherein, the identity information identifies an association relationship between reference signal ports comprised in a plurality of reference signal resource sets associated with the second antenna switching method and antenna ports of the first node.

According to still another embodiment of the present disclosure, there is provided a node device in a communication system. The node device includes: a transceiver; and a processor, coupled to the transceiver and configured to execute any of the above methods.

The present disclosure designs a method and apparatus for transmitting and receiving reference signals in a wireless communication network, so as to implement an association relationship between the antenna ports for transmitting the reference signals and the reference signal resources.

### Advantageous Effects of Invention

Aspects of the present disclosure provide efficient communication methods in a wireless communication system.

### BRIEF DESCRIPTION OF DRAWINGS

FIG. 1 illustrates an example wireless network according to various embodiments of the present disclosure;

FIGS. 2a and 2b illustrate example wireless transmission and reception paths according to embodiments of the present disclosure;

FIG. 3a illustrates an example UE according to an embodiment of the present disclosure;

FIG. 3b illustrates an example gNB according to an embodiment of the present disclosure;

FIG. 4 illustrates a schematic diagram of CSI inference for different antennas based on a neural network according to an embodiment of the present disclosure;

FIG. 5 illustrates a diagram of operations of an adaptive neural network according to an embodiment of the present disclosure;

FIG. 6 illustrates a flowchart of adjustment of an adaptive neural network according to an embodiment of the present disclosure;

FIG. 7 illustrates a method for configuring and transmitting reference signals by a first node in a communication network according to an embodiment of the present disclosure;

FIG. 8 illustrates a method for receiving reference signals by a second node in a communication network according to an embodiment of the present disclosure;

FIG. 9 illustrates a block diagram of a structure of a first node for transmitting reference signals according to an embodiment of the present disclosure;

FIG. 10 illustrates a block diagram of a structure of a second node for receiving reference signals according to an embodiment of the present disclosure;

FIG. 11 illustrates a block diagram illustrating a structure of a UE according to various embodiments of the present disclosure; and

FIG. 12 illustrates a block diagram illustrating a structure of a base station according to various embodiments of the present disclosure, as disclosed herein.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

The technical solutions of the embodiments of the present application can be applied to various communication systems, for example: global system for mobile communications (GSM), code division multiple access (CDMA) system, wideband code division multiple access (WCDMA) system, general packet radio service (GPRS), long term evolution (LTE) system, LTE frequency division duplex (FDD) system, LTE time division duplex (TDD), universal mobile communication system (UMTS), worldwide interoperability for microwave access (WiMAX) communication system, 5th generation (5G) system or new radio (NR), etc. In addition, the technical solutions of the embodiments of the present application can be applied to future-oriented communication technologies.

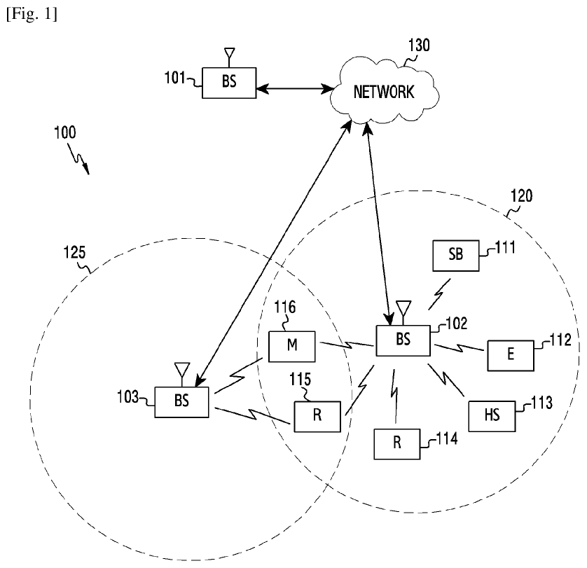

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

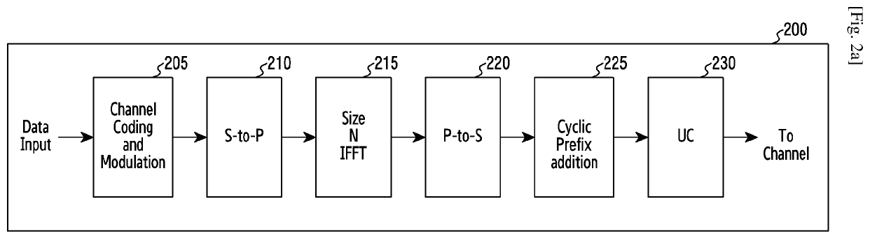

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

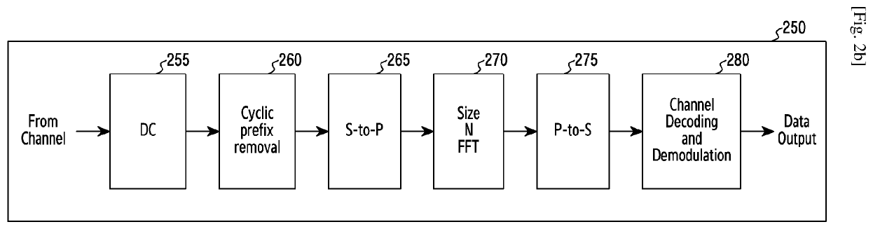

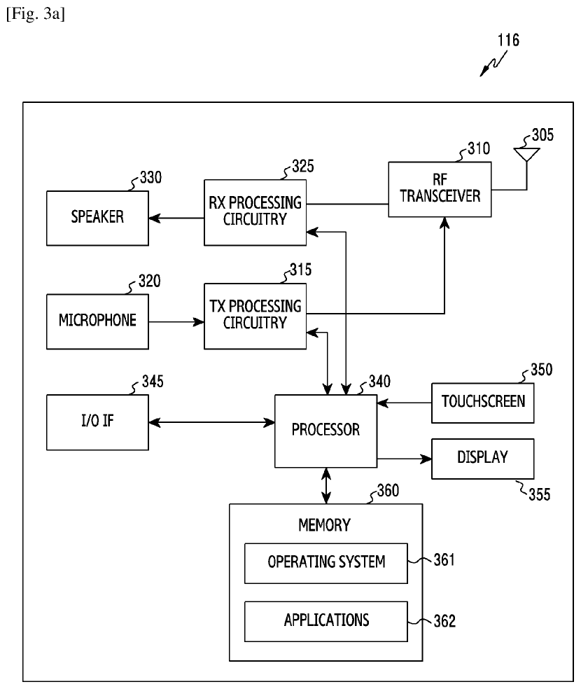

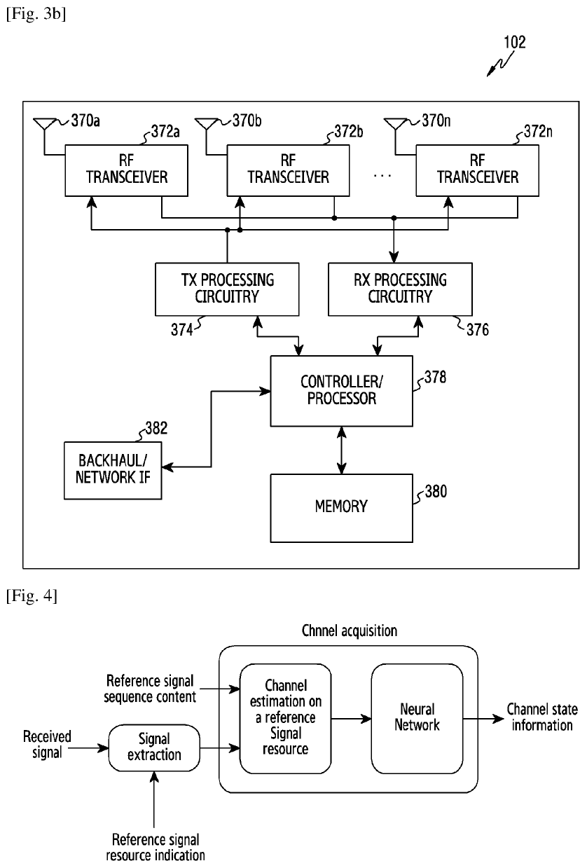

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

In a wireless communication system, one of the main measures to ensure a communication rate and reliability is to process a signal through channel state information (CSI) at both transmitting and receiving ends, for example, to precode the transmitted signal at the transmitting end, and perform channel equalization on the received signal at the receiving end, so as to eliminate influence of the channel on the signal as much as possible. However, due to complex and variable characteristics of the wireless channel, how to accurately obtain channel state information is one of the biggest challenges in the wireless communication. At present, prosperity and development of smart devices and related applications stimulate the user's demand for faster wireless communication with lower latency. These requirements prompt the wireless communication network to evolve toward wider frequency bands and more antennas. Correspondingly, the resources required and difficulty to obtain wireless channel state information also increase accordingly. In order to further improve the spectrum efficiency of wireless communication systems, how to efficiently obtain channel state information is regarded as one of the key challenges of future wireless communication systems in both industry and academia.

In order to achieve the above signal processing, the base station or device needs to obtain the channel state information of each transmitting antenna in all time units and all frequency units of information transmission, where the time unit can be a subframe, a subframe includes two time slots, and the frequency unit may be a resource block (RB), and each RB includes NRB subcarriers or resource elements (REs), such as 12 REs. Without loss of generality, the channel state information in the present disclosure may be a channel state matrix, eigenvalues and eigenvectors of a channel after singular value decomposition, channel precoding matrix indicator, channel quality information, channel layer indication, channel rank indicator, etc. Without loss of generality, the antenna in the present disclosure is a generalized antenna, which may be a physical antenna element, or an antenna array including multiple physical antenna elements, or an antenna panel, or a beam, or a precoding matrix at the transmitting end, etc. Without loss of generality, the frequency unit in the present disclosure may be a sub-band, a bandwidth part (BWP), and a subcarrier, a carrier, a physical resource block (PRB), a resource block group (RBG), etc. For example, in LTE and NR, a frequency unit may be a subcarrier that includes a frequency range of 15 kHz.

Without loss of generality, information transmission will take place on no less than one continuous frequency unit. The method of obtaining channel state information for a certain antenna is to select some frequency units with certain rules in its working frequency band to transmit a reference signal (RS), and infer the wireless channel state information accordingly. The system may simultaneously transmit non-reference signals, such as a data signal and/or a control signal, on other frequency points in this frequency band. The reference signal is a transmitted signal composed of a generated sequence, and its content and the time unit and frequency unit where it is transmitted are shared by both the transmitting and receiving ends. The reference signal may also be called a pilot signal, a training signal, etc. Currently, the most widely used wireless communication systems are cellular communication systems based on 3GPP protocols, for example, 4G communication systems such as LTE and LTE-A, and 5G communication systems such as NR. In LTE-A and NR systems, the channel state information can be obtained by transmitting a channel state information reference signal (CSI-RS), a sounding reference signal (SRS), and a demodulation reference signal (DM-RS), etc.

In order to improve the accuracy of CSI acquisition and reduce the resource overhead of reference signals, some current research considers the use of neural networks to achieve CSI acquisition. According to different application scenarios, the neural networks include at least one of following functions: obtain the CSI on the frequency unit where the signal is located according to the received reference signal, infer the CSI of the frequency unit without reference signal configured in the frequency domain, and infer the CSI of the antenna without the reference signal configured in the antenna domain, such as inference of the CSI of the antenna without the reference signal configured. The neural networks include but are not limited to a multilayer perceptron (MLP), a convolutional neural network (CNN), a deep neural network (DNN), a recurrent neural network (RNN), a restricted Boltzmann machine (RBM), a graph neural network (GNN), a deep belief network (DBN), a bidirectional recurrent deep neural network (BRDNN), a generative adversarial network (GAN), a transformer network, etc.

FIG. 4 illustrates a schematic diagram of CSI inference for different antennas based on a neural network according to an embodiment of the present disclosure.

As shown in FIG. 4, a receiver can obtain the CSI on an antenna where an RS is located by performing channel estimation on a reference signal resource used to transmit the RS, and then input the obtained CSI into a trained neural network, and finally obtain the CSI of all antennas by using the neural network.

In practice, the neural network generally does not have the ability of adaptive structure adjustment. For example, the neural network can be obtained by training an offline data set, where the offline data set can be obtained through artificial generation, e.g., the offline data set is generated through a random process; and then the trained neural network is deployed to online inference, and the structure and parameters of the neural network will not be adjusted during the online inference process. However, the main problems caused by using such a neural network for CSI acquisition are: 1) the variable characteristic of the wireless channel makes it difficult to obtain an offline data set with similar characteristics to online CSI, which leads to a decrease in the accuracy of the neural network trained by offline data after being deployed online; 2) in order to ensure the generalization of the neural network model, the above neural network without adaptive structural adjustment is often composed of a relatively large number of neurons, which will cause a large-scale neural network model deployed online to occupy a large amount of computing resources, and suffer from a large inference latency, which thus increases the difficulty of training; 3) the wireless channel may change due to changes in the physical environment, and the above neural network does not support adjustment of online weight parameters and the structure, which will lead to a decrease in accuracy of the CSI acquisition of the deployed neural network after the deployed physical environment changes.

According to an embodiment of the present disclosure, there is provided an adaptive neural network for obtaining channel state information (CSI) in a communication node, which is configured to: adjust, by the communication node, the neural network based on the received reference signals transmitted by all of the one or more antenna ports; and infer, by the communication node, CSI of antenna ports in the one or more antenna ports that do not transmit reference signals through the adjusted neural network based on the received reference signals transmitted by some of the one or more antenna ports; wherein, in both the adjustment and inference process of the neural network, the reference signals are transmitted by the one or more antenna ports via one or more reference signal ports corresponding to the one or more antenna ports based on an association relationship between the one or more antenna ports and the one or more reference signal ports indicated in the configuration information determined according to the configuration information.

In the adaptive neural network according to the embodiment of the present disclosure, adjusting, by the communication node, the neural network based on the received reference signals transmitted by all of the one or more antenna ports, includes: obtaining, by the communication node, channel state information (CSI) of the reference signals of the one or more antenna ports by performing channel estimation on one or more reference signal resources for transmitting the reference signals of the one or more antenna ports, so as to form a CSI data set; and adjusting the neural network based on the CSI data set.

The adaptive neural network according to the embodiment of the present disclosure, further includes: determining, by the communication node, whether to adjust the neural network based on a threshold.

In the adaptive neural network according to the embodiment of the present disclosure, the threshold includes a neural network complexity threshold and/or a neural network accuracy threshold.

In the adaptive neural network according to the embodiment of the present disclosure, adjusting the neural network based on the CSI data set, includes: adjusting weight parameters of the neural network and/or a structure of connection between neurons of the neural network and/or a data format in which the weight parameters of connections in the neural network are stored based on the CSI data set.

In the adaptive neural network according to the embodiment of the present disclosure, model pruning is used to adjust the structure of connection between neurons of the neural network.

In the adaptive neural network according to the embodiment of the present disclosure, adjusting the data format in which the weight parameters of connections in the neural network are stored, includes: converting the weight parameter from a first data format to a second data format; and determining a mapping relationship between the first data format and the second data format.

In the adaptive neural network according to the embodiment of the present disclosure, determining a mapping relationship between the first data format and the second data format, includes: if a precision of the second data format is less than that of the first data format, clustering all the weight parameters of the neural network in the first data format, and mapping weight parameters of each category to the second data format.

The adaptive neural network according to the embodiment of the present disclosure, further includes: when the communication node determines to adjust the neural network, adjusting, by the communication node, reference signals that are to be received and are transmitted by the one or more antenna ports and the one or more reference signal ports; or when the communication node determines to adjust the neural network, transmitting, by the communication node, control signaling to an other communication node to notify the other communication node to adjust reference signals that are to be received and are transmitted by the one or more antenna ports and the one or more reference signal ports.

The adaptive neural network for CSI acquisition provided according to the embodiment of the present disclosure can implement adaptive adjustment of the weight parameters and/or structure of the neural network according to CSI data samples obtained online, which thus avoids performance degradation of the neural network caused by a lack of generalization of the model, avoids performance degradation caused by underfitting of the neural network due to environmental changes, and meanwhile reduces inference complexity of the neural network to achieve a decrease in computing resource consumption and inference latency. The method can be applied to both the network side (such as a base station) and the terminal side.

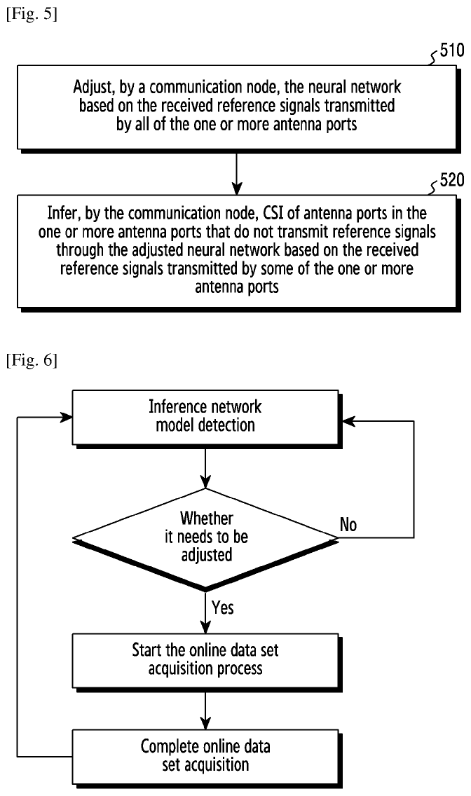

FIG. 5 illustrates a diagram of operations of an adaptive neural network according to an embodiment of the present disclosure.

As shown in FIG. 5, in operation 510, a communication node may adjust the neural network based on received reference signals transmitted by all of the one or more antenna ports. According to the embodiment of the present disclosure, the communication node may include but not limited to a base station, a terminal (such as UE) and the like. According to the embodiment of the present disclosure, the communication node may receive reference signals transmitted by one or more antennas of another communication node, and the communication node may adjust the adaptive neural network in the communication node based on the received reference signals, for example, which includes but is not limited to that, the communication node may adjust weight parameters and/or neural network structure of the adaptive neural network based on the received reference signals.

In operation 520 shown in FIG. 5, the communication node infers CSI of antenna ports in the one or more antenna ports that do not transmit reference signals through the adjusted neural network based on the received reference signals transmitted by some of the one or more antenna ports. After the neural network is adjusted based on the reference signals transmitted by one or more antenna ports, the adjusted neural network can be used to infer the CSI of the antenna ports during communication. For example, the inference process may be to receive reference signals transmitted by some of the one or more antenna ports, and infer the CSI of the antenna ports that do not transmit reference signals based on the received reference signals transmitted by some of the antenna ports.

According to the operations of the adaptive neural network shown in FIG. 5, the adaptive adjustment of the weight parameters and structure of the neural network can be implemented according to the CSI data samples obtained online, and meanwhile the number of resources configured in the inference process can be reduced to lower the inference complexity of the neural network so as to achieve a decrease in the computational resource consumption and inference latency.

For the adaptive neural network for channel state information acquisition according to the embodiment of the present disclosure, the communication node (such as a base station, a terminal, etc.) can receive reference signals of all antennas, perform channel estimation on reference signal resources of these reference signals, and obtain CSI to form an online CSI data set, and adjust the neural network for online inference of the CSI according to the CSI data samples obtained online, for example, adjusting the neural network may include but not limited to adjusting the weight parameters and/or neural network structure, wherein, the neural network structure means a structure of connection of each neuron in the neural network (that is, whether the neurons between any two adjacent layers are connected) and/or a data format in which the weight parameters of all connections are stored in memory (including a data type stored and a number of bytes of memory occupied).

For the sake of brevity, unless otherwise specified, the “neural network for CSI acquisition” will be referred to as “neural network” in the following, and the “neural network model deployed on the communication node for online inference of CSI” will be referred to as “inference network model” in the following; hereinafter, the “baseline neural network model for adaptive adjustment of the neural network to obtain the inference network model” is simply referred to as the “baseline network model”.

FIG. 6 illustrates a flowchart of adjustment of an adaptive neural network adjustment according to an embodiment of the present disclosure.

In the embodiment shown in FIG. 6, the inference network model can determine whether to acquire the online CSI data set by detecting the performance, wherein, the detection of the performance of the inference network model can be that the communication node sets a start switch for the adaptive adjustment of the neural network according to its own requirements for the performance of the neural network, and the start of the adaptive adjustment of the neural network is determined by the communication node detecting a performance index of the current neural network. For example, the performance index of the neural network can be inference complexity and/or CSI inference accuracy of the current inference network model, and the communication node will set a CSI neural network inference complexity threshold and/or a CSI inference accuracy threshold in the deployment phase. If the communication node detects that the inference complexity of the current inference network model is higher than the complexity threshold and/or the CSI inference accuracy is lower than the accuracy threshold, an online CSI data set acquisition process is started. It should be understood that the above threshold for starting the adaptive adjustment of the neural network is only an example, and other types of thresholds may also be used according to the embodiments of the present disclosure.

According to the embodiment of the present disclosure, the meaning of the inference complexity may include but not limited to one or more of following: a total number of neural network neurons, a number of floating-point operations (FLOPs) for neural network inference, and time consumed by the neural network inference, etc.; wherein, the CSI inference accuracy cannot be obtained directly, so it can be reflected by one or more of the following performances of obtaining the CSI based on the neural network for uplink transmission, including but not limited to a difference between an actual throughput and an estimated throughput, a difference between an actual spectrum efficiency and an estimated spectrum efficiency, and a frequency at which the base station receives a negative acknowledgment (NACK), etc.; wherein, the inference complexity threshold and the CSI inference accuracy threshold of the communication node may be determined according to an upper limit of the computational complexity supported by the communication node and a lowest tolerable uplink transmission performance.

In some examples, when the neural network is located on the base station side, the base station detects the inference complexity and/or CSI inference accuracy of the current inference network model at a certain frequency, and the frequency of detection can be determined by a speed of changes in the environment where the base station is located. When the base station detects that the inference complexity of the inference network model is higher than the complexity threshold and/or the CSI inference accuracy is lower than the accuracy threshold, the base station starts the online CSI data set acquisition process. Exemplarily, the base station adjusts a format of the reference signals transmitted by the terminal and corresponding radio resources according to the needs of the required training samples, and notifies the terminal of relevant information through scheduling or control signaling (such as higher layer signaling, etc.).

In some examples, when the neural network is located on the terminal side, the terminal detects the inference complexity and/or CSI inference accuracy of the current inference network model at a certain frequency, and the frequency of detection can be determined by the speed of changes in the environment where the base station is located. When the terminal detects that the inference complexity of the inference network model is higher than the complexity threshold and/or the CSI inference accuracy is lower than the accuracy threshold, the terminal starts the online CSI data set acquisition process. Exemplarily, the terminal notifies the base station that the terminal needs to start the online CSI data set acquisition process through the second control signaling (for example, higher layer signaling, etc.).

In some examples, after the communication node (such as a base station, a terminal, etc.) calculates the CSI of the reference signal using a channel estimation method and stores the CSI in a fixed location in memory to form an online CSI data set, the current inference network model can be replaced by a backup of the benchmark network model, and the weight parameters and/or neural network structure of the replaced inference network model are adjusted at least one round based on the online CSI data samples obtained according to the preset threshold.

Exemplarily, the reference network model is a neural network model directly deployed by the communication node in the deployment phase for CSI acquisition. Optionally, the reference network model can be acquired by the communication node at any time by starting online CSI data set acquisition, and trained according to the acquired data set. Optionally, at any moment, the communication node may replace the reference network model with the inference network model currently used for online CSI acquisition and store it in the memory for use in a next model adaptive adjustment. Optionally, the communication node can also replace the existing benchmark model with the inference network model obtained after any adjustment round in the model adaptive adjustment, and store it in the memory for the next model adaptive adjustment (the inference network model obtained in the model adaptive adjustment described here may be an inference network model whose model has not been adjusted beyond the threshold set by the system).

Exemplarily, when a preset adaptive adjustment switch is determined by the CSI inference accuracy as a threshold, the communication node can adjust the neural network every round according to following combinations, including: 1) adjust the weight parameters of the neural network separately; 2) adjust the structure of the connection between neurons in the neural network and adjust the weight parameters of the neural network. When the preset adaptive adjustment switch is determined by the inference complexity threshold alone as the threshold, or by the inference complexity threshold and the CSI inference accuracy as the threshold, the communication node can adjust the neural network every round according to following combinations, including: 1) separately adjust a data type and length of the parameters of each connection in the neural network stored in the memory; 2) adjust the structure of the connection between neurons in the neural network and adjust the weight parameters of the neural network; 3) adjust the weight parameters of the neural network and adjust the data type stored in the parameters of each neuron in the neural network and the size of the occupied memory; 4) adjust the structure of the connection between neurons in the neural network, adjust the weight parameters of the neural network, and adjust the data type and length of the parameters of each connection in the neural network stored in the memory.

Exemplarily, the adjustment of the weight parameters of the neural network is to use the online CSI data set to train the neural network model. The training is stopped when the training is sufficient, which means, for example, that the performance of the currently trained neural network is higher than the preset CSI inference accuracy threshold.

Exemplarily, the communication node adjusts the structure of the connection between neurons in the neural network by using a model pruning method to prune the connection of each neuron in middle layers of the neural network. When any round of model adaptive adjustment includes model pruning, the communication node needs to perform the following two steps in sequence: 1) performing model pruning on the connections of all neurons in the middle layer of the inference network model; 2) using the online CSI data set to train and tune the inference network model.

Wherein, the meaning of pruning is to delete or retain the connection of each neuron in the neural network according to a pruning threshold. If the connection exceeds the threshold, the connection is retained, and if the connection is lower than the pruning threshold, the connection is discarded. Wherein, the discarding operation can be to reset the weight of the connection to zero, or directly delete the parameters corresponding to the connection from the memory. Wherein, for example, in the pruning operation for a certain connection, the smaller the value of the connection weight, the less the contribution to the output, so those connections whose weight value is lower than the preset pruning threshold are directly pruned. The pruning threshold can be obtained through a function. This function can be obtained by multiplying a quality parameter by a standard deviation, mean or L1/L2 norm of all weights of the neural network. The meaning of the quality parameter is a pruning ratio in this round of pruning. The higher the quality parameter, the greater the pruning ratio. After the communication node prunes the inference network model, the number of connections between neurons will be reduced to the pruning ratio corresponding to the quality parameter. The inference network model after the pruning of the communication node can be directly used to obtain online CSI. Optionally, the communication node uses the online CSI data set to train the pruned inference network model, that is, to perform parameter tuning on the remaining weights in the pruned inference network model. The communication node can stop the training when the training is sufficient, which means that the performance of the currently trained neural network is higher than the preset CSI inference accuracy threshold.

Optionally, the communication node may only perform one round of model pruning and weight parameter adjustment, and use the adjusted inference network model to obtain the online CSI after these two steps are completed. Optionally, the communication node can perform multiple rounds of model pruning and weight parameter adjustment, and set different quality parameters in each round in order to achieve a specific proportion of neuron connections in this round of pruning. Optionally, the communication node sets for each round of pruning similar weight parameters or weight parameters that decrease as rounds increase according to a final desired model complexity to achieve an average or incremental pruning ratio. Compared with a single-round model pruning, multiple rounds of progressive pruning can be used to achieve higher CSI inference accuracy while pruning the model to the same complexity.

Exemplarily, the method for the communication node to adjust the data format in which the weight parameters of each connection in the neural network are stored in memory is model quantization. Wherein, the meaning of the data format is the data type of the weight parameter to be stored and the number of bytes of memory occupied, where the data type can be a floating-point number, an integer, etc. The method for the communication node to quantize the weight parameters of all connections of the inference network model is to convert the first data format in which the weights are stored in the memory into the second data format. The conversion of the data format can be in one of following three modes: 1) conversion of the same data type and different occupied memory length (for example, converting from 64-bit floating-point number data format to 32-bit floating-point number data format); 2) conversion of different data types with the same memory length (for example, converting 16-bit floating-point number data format to 16-bit integer data format); 3) conversion of different data types and different lengths (for example, converting 64-bit floating-point number data format to 8-bit integer data format). The conversion of the data format of the weight parameter requires following two steps in order: 1) a target data format is selected according to demand of the communication node for the complexity of the inference network model; 2) if precision of the second data format is less than that of the first data format, all the weight parameters of the inference network model are clustered in the first data format (before the data format is not converted), and the weight parameters of each category are mapped to the second data format.

The target data format of the communication node when quantizing the model is selected by considering two aspects of the data format supported by the device during calculation and the complexity of the inference network model. In most devices, efficiency of the integer operation is higher than that of the floating-point number operation. Therefore, when a device supports the integer operation, the device preferably chooses to convert the data type of the inference network model from the floating-point number to an integer. Generally speaking, every time the memory occupied by the data format of the inference network model is reduced by half, the complexity of the operation will be reduced by about 25%. A communication device selects the memory length occupied by the data format of connection in the inference network model according to target complexity of the CSI inference. For example, when the data format of the baseline network model of the communication device is a 64-bit floating-point number, and an aim of the communication device is to use model quantization to reduce the complexity of CSI inference by 50%, then it can be chosen to quantize the data format of the inference network model from a 64-bit floating-point number to a 16-bit integer.

After the communication node selects the target data format (the second data format), all weight parameters of the inference network model are clustered in the first data format (before the data format is not converted), and the same weight parameters in the first data format will share weight parameters in the second data format. The reason why the communication node needs to cluster all the weight parameters of the inference network model is that if the precision of the second data format is less than that of the first data format, a number of different weight parameters expressed in the first data format may be greater than a total amount of different data supported by the second data format. For example, if the data format of the baseline network model is a 64-bit floating point number and the second data format is an 8-bit integer, the total number of different data that the second data format can support is 256, while in a case where the inference network model is expressed in the first data format, the number of different weight parameters may be much greater than 256. The clustering method can be equidistant clustering, k-mean clustering, etc.

Optionally, the communication node may cluster the weight parameters using an equidistant clustering method in the first data format. Exemplarily, a total amount N of different data that can be supported is calculated according to the precision of the second data format, and a maximum value ωₘₐₓ and a minimum value ωₘᵢₙ of all weight parameters are calculated. The communication node takes ωₘₐₓ as an upper limit and ωₘᵢₙ as a lower limit, and divides a range within the upper and lower limits into N categories on average, where the range included in each category is

$$\frac{{ω}_{max} - {ω}_{min}}{N} ,$$

and in the first data format, the weights whose weight parameter values fall within a certain category range are classified into one category. After the clustering is completed, all weight parameters of the inference network model are mapped to the second data format according to the clustered category.

Optionally, the communication node may use the k-mean clustering method to cluster the weight parameters in the first data format. A total weight of the inference network model in the first data format is M, expressed as {α₁, α₂, α₃, . . . , α_{M}}, where αₘ, m∈[1, M] indicates a value of an m-th weight in the first data format. The second data format contains a total of K sets (K<M), expressed as {β₁, β₂, β₃, . . . , β_{K}}, where βₖ, k∈[1, K] indicates a value of weight corresponding to an k-th set in the second data format. M weights in the first data format can be clustered by a following formula and mapped to the second data format:

$${arg max}_{K} {\sum }_{i = 1}^{k} {\sum }_{α ∈ {β}_{i}} {\vert α - {β}_{i} \vert}^{2}$$

In order to implement the inference and adaptive structure adjustment of the neural network for channel state information (CSI) acquisition between antennas according to the above embodiments, the communication node (such as a base station, a terminal, etc.) needs to obtain the CSI of an antenna position where the reference signal is located, and store the CSI in a fixed location in the memory to form an online CSI data set. For example, in a case where the base station obtains the channel state information of the antenna of the terminal, the terminal needs to be configured with at least two different sets of reference signal resources, wherein, reference signals configured in a first reference signal resource set need to conform to a reference signal resource and antenna mapping method required by the neural network for CSI acquisition to perform adaptive structure adjustment, and reference signals configured in a second reference signal resource set need to conform to the reference signal resource and antenna mapping method required by the neural network for CSI acquisition to perform inference. Without loss of generality, the antenna in the present disclosure is a generalized antenna, which may be a physical antenna element, or an antenna array including multiple physical antenna elements, or an antenna panel, or a beam, or a precoding matrix at the transmitting end, etc. For the sake of simplicity of description, unless otherwise specified, the “neural network for CSI acquisition” will be referred to as the “neural network” in the following; and in the following description, the case where the base station performs channel estimation on an uplink reference signal resource to obtain the channel state information of the antenna of the terminal (such as UE) will be taken as an example to describe the embodiment according to the present disclosure, wherein, an uplink reference signal may be a sounding reference signal (SRS), but it should be understood that the embodiment of the present disclosure can be applied to reception and transmission of reference signals between any communication nodes (such as base stations, terminals, etc.) in the communication network. For example, the method according to the embodiment of the present disclosure may also be applied to the case where a terminal (such as UE) performs channel estimation on a downlink reference signal resource to obtain channel state information of an antenna of a base station, wherein, a downlink reference signal may be a channel state information reference signal (CSI-RS).

Currently, in the protocol, a user (UE) implements uplink CSI measurement by being configured and transmitting a sounding reference signal (SRS), wherein, the UE may be configured with an SRS whose transmission usage is antenna switching, and is used for the base station to acquire uplink CSI of each UE transmitting antenna port according to the SRS. Exemplarily, the UE will first report radio access capability information, which includes UE antenna switching capability. Afterwards, the UE can be configured with no less than one uplink reference signal resource or resource set to configure the SRS resource required for antenna switching, and the UE can only be configured with one antenna switching method (according to the indicated user capability) for uplink reference signal transmission at a time. The UE will be implicitly configured with an antenna switching method by the SRS resource contained in the uplink reference signal resource, and the UE will be indicated that the transmitting antenna port for the uplink reference signal corresponding to each SRS resource cannot be the same.

In the prior art above, the reason that the UE is only configured with one antenna switching method for transmitting the uplink reference signal at a time is that only one antenna switching configuration is required for the base station to obtain the uplink reference signal of each antenna port of the UE. In order to support the SRS antenna switching, the UE may be configured with more than one uplink reference signal resources or resource sets, wherein, the reason for configuring more than one uplink reference signal resource sets is that each uplink reference signal resource set can only contain resource configuration in one slot, and the amount of resources available for SRS in one slot may be less than the amount of resources required for antenna switching. For the behavior of the UE transmitting the uplink reference signal to implement antenna switching, the UE will only be indicated that the UE antenna port for transmitting the uplink reference signal corresponding to each SRS resource cannot be the same, and will not be configured a mapping relationship between each SRS resource and the UE antenna port. Therefore, the UE can determine on its own the mapping relationship between the SRS resource and the UE antenna port according to the configured antenna switching method. The reason that the UE is not configured with the mapping relationship between the SRS resource and the transmit port for the uplink reference signal is that different mapping relationships will not affect the result of the base station obtaining the uplink CSI of each UE transmitting antenna port. Taking the UE configured with an uplink reference signal resource set for xTyR antenna switching as an example, “xT” means that the UE can transmit SRS on x antenna ports each time the antenna is switched, and “yR” means that the UE needs to transmit the SRS on y antenna ports in total. Therefore, the UE needs to perform y/x times of antenna switching in total. Taking x=1 and y=4 as an example, the UE needs to perform SRS transmission on 4 different antenna ports through 4 times of antenna switching, wherein, the SRS resource set configured by the UE for antenna switching includes 4 SRS resources and is distributed on different OFDM symbols, and through the above resource configuration, the UE is implicitly indicated that the SRS antenna switching method is “1T4R”. The UE will be configured with 4(a+b) OFDM symbols to perform SRS transmission for 4 times, where, a represents a number of OFDM symbols required to transmit the SRS on one antenna port, b represents a number of OFDM symbols required to perform a guard period of antenna switching, and a number of symbols contained in 4(a+b) needs to be less than the total number of symbols in a slot. At the same time, the UE needs to ensure that different antenna ports are used to transmit the SRS each time the antenna is switched.

When the neural network deployed in the base station needs to infer the CSI of the antenna port that is not configured a reference signal according to the CSI on the transmitting antenna port corresponding to the received SRS, the operation (such as inference, and adaptive structure adjustment) of the neural network needs to know the UE transmitting antenna port corresponding to each resource of the received SRS. Because the antenna switching configuration in the current protocol does not directly specify the antenna port of the UE corresponding to the SRS resource to transmit the SRS, so that the neural network deployed by the base station cannot know the association relationship between the SRS resource and the antenna port of the UE, resulting in the failure of the neural network to run. Moreover, when the neural network deployed by the base station needs to run two functions of inference and adaptive structure adjustment at the same time, the UE needs to be configured with at least two different antenna switching methods for transmitting the SRS for antenna switching purposes. However, the existing protocol only supports that the same UE is configured with one antenna switching method at a time to transmit the SRS for antenna switching purposes, so it cannot meet the requirements of simultaneously performing neural network reasoning and adaptive structure adjustment at the base station.

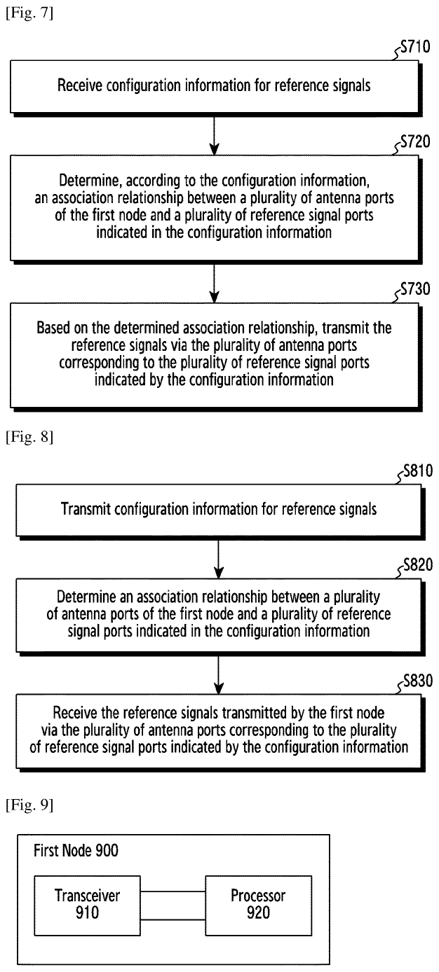

FIG. 7 illustrates a method for configuring and transmitting reference signals by a first node in a communication network according to an embodiment of the present disclosure.

As shown in FIG. 7, in step S710, the first node receives configuration information for the reference signals. Wherein, the first node may be any communication node in the communication network, for example, a base station, a terminal, etc. According to the embodiment of the present disclosure, the configuration information may be, for example, higher-level signaling, control signaling, or scheduling signaling, etc., but the embodiments of the present disclosure are not limited thereto.

In step S720, the first node may determine, according to the configuration information, an association relationship between a plurality of antenna ports of a first node and a plurality of reference signal ports indicated in the configuration information.

In step S730, the first node may, based on the determined association relationship, transmit the reference signals via the plurality of antenna ports corresponding to the plurality of reference signal ports indicated by the configuration information.

According to the embodiment shown in FIG. 7, the association relationship indicates that each reference signal port indicated by the configuration information corresponds to one antenna port of the first node.

FIG. 8 illustrates a method for receiving reference signals by a second node in a communication network according to an embodiment of the present disclosure;

As shown in FIG. 8, in step S810, the second node transmits configuration information for the reference signals. Wherein, the second node may be any communication node in the communication network, for example, a base station, a terminal, etc. According to the embodiment of the present disclosure, the configuration information may be, for example, higher-level signaling, control signaling, or scheduling signaling, etc., but the embodiments of the present disclosure are not limited thereto.

In step S820, the second node may determine an association relationship between a plurality of antenna ports of the first node and a plurality of reference signal ports indicated in the configuration information.

In step S830, the second node may receive the reference signals transmitted by the first node via the plurality of antenna ports corresponding to the plurality of reference signal ports indicated by the configuration information.

According to the embodiment shown in FIG. 8, the association relationship indicates that each reference signal port indicated by the configuration information corresponds to one antenna port of the first node.

By using the reference signal configuring and transmitting method shown in FIG. 7 and the reference signal receiving method shown in FIG. 8, according to the embodiments of the present disclosure, a mapping relationship between a reference port included in a reference resource set and an antenna port transmitting the reference signals may be configured, and such mapping relationship may be kept in different reference signal transmissions. For example, according to the embodiments of the present disclosure, in the example of the base station obtaining channel state information of an antenna of a terminal (e.g., a user equipment (UE)), the UE may obtain an association relationship between an uplink reference signal resource transmitting SRS and the antenna port according to the configuration information, and perform SRS antenna switching in sequence through the association relationship. Through the above-described functions, the base station may obtain the association relationship between the SRS resources and the antenna ports used by the user to transmit SRS, so as to implement inference and adaptive structure adjustment of the neural network obtaining uplink CSI. During the process of the base station obtaining uplink CSI, inference performed by using the neural network is inferring, through CSI of some antenna ports of the UE that transmit SRS, CSI of other antenna ports of the UE that do not transmit SRS, so the UE only needs to transmit SRS on some antenna ports to support the base station in obtaining all CSI related to the UE, which, thus, may reduce the number of SRS resources configured for the UE and save overhead of uplink reference signal resources. Meanwhile, the number of SRS antenna switching performed by the UE will also decrease accordingly with decrease in the number of SRS configuration resources, so the number of communication interruptions caused by the UE performing antenna switching (communication interruptions occur within a guard period of each round of antenna switching) will also decrease accordingly. Meanwhile, the method may allow a same UE is simultaneously configured with a variety of different antenna switching methods for uplink reference signal transmission for antenna switching purposes; by receiving SRS of different antenna switching configurations, the neural network at the base station may simultaneously perform inference and adaptive structure adjustment, so that the neural network at the base station may implement efficient adaptive structure adjustment, which, thus, increases accuracy of CSI acquisition and reduces inference latency and computational resource overhead of the neural network.

The method for transmitting and receiving the reference signal according to the embodiment of the present disclosure may be applied to an uplink reference signal or a downlink reference signal. For example, the first node may be a user equipment (UE), and the second node may be a base station. At this time, the first node may receive configuration information, determine an association relationship between the antenna ports of the first node and the uplink reference signal ports in the configuration according to the configuration, and then the first node may transmit the uplink reference signals on the associated antenna ports. In addition, in a case where the downlink reference signal is applied, the first node may receive configuration information, determine an association relationship between the antenna ports of the second node and the downlink reference signal ports in the configuration according to the configuration, and then the first node receives the downlink reference signals transmitted on the associated antenna ports on the reference signal port.

For example, when the configuration received by the first node is the uplink reference signal related configuration, the configuration received by the first node includes no less than one uplink reference signal resource set (the uplink reference signal resource set may be sounding reference signal resources (SRS-Resources), sounding reference signal resource sets (SRS-ResourcesSets), or other uplink reference signal configuration sets). Wherein, each uplink reference signal resource set in the configuration received by the first node includes no less than one uplink reference signal resource, wherein, the reference signal resource represents a time-frequency resource used to transmit a reference signal, and a reference signal resource may be associated with one or more reference signal ports. The reference signal port represents a logical port used to transmit a reference signal; a reference signal port may be associated with an antenna port of the first node; and the reference signal port may be an SRS port. The antenna port of the first node represents an antenna port where the first node may independently transmit signals; the antenna port may be a physical antenna element, a physical antenna array, a physical antenna panel, etc. of the first node. The first node associates each antenna port with an uplink reference signal port according to configured indication, and transmits an uplink reference signal on resources associated with each antenna port.

For example, when the configuration received by the first node is the downlink reference signal related configuration, the configuration received by the first node includes no less than one downlink reference signal resource set (the downlink reference signal resource set may be channel state information reference signal resources (CSI-RS-Resources), channel state information reference signal resource sets (CSI-RS-ResourcesSets) or other uplink reference signal configuration sets). Wherein, each downlink reference signal resource set in the configuration received by the first node includes no less than one downlink reference signal resource; wherein, one reference signal port may be associated with an antenna port of the second node, and the reference signal port may be a CSI-RS port. The antenna port of the second node represents an antenna port where the second node may independently transmit signals; and the antenna port may be a physical antenna element, a physical antenna array, a physical antenna panel, etc. of the second node.

For simplicity of description, unless otherwise specified, the antenna port association relationship mentioned hereinafter is “the association relationship between the antenna ports of the UE and the uplink reference signal ports in the configuration”; however, it should be understood that the embodiment of the present disclosure may be applied to reception and transmission of reference signals between any communication nodes (e.g., a base station, a terminal, etc.) in a communication network, for example, the method according to the embodiment of the present disclosure may also be applied to a case where a terminal (e.g., a user equipment UE) performs channel estimation on the downlink reference signal resource to obtain the channel state information of the antenna of the base station, wherein, the downlink reference signal may be the channel state information reference signal CSI-RS. Hereinafter, an example embodiment of the UE determining the antenna port association relationship will specifically described.

### Improvement Based on Existing Antenna Port Association Relationship

In some examples, the determining, by the UE according to the configuration information, an association relationship between a plurality of antenna ports of the UE and a plurality of reference signal ports indicated in the configuration information, includes: associating each antenna port of the UE with one different reference signal port according to the configuration information, and keeping the association relationship between the plurality of antenna ports and the plurality of reference signal ports consistent in a same cell. For example, the UE respectively receives configuration information of the first reference signal resource set and the second reference signal resource set in the same cell; according to the configuration information, the UE respectively corresponds the reference signal ports 300x1 and 300x2 to the antenna port 1 and the antenna port 2 of the UE; and the UE respectively applies the reference signal association relationship to the first and second reference signal resource sets. In the same cell, at different time, the UE receives a third reference signal resource set; according to the configuration information, the UE also respectively corresponds the reference signal ports 300x1 and 300x2 to the antenna port 1 and the antenna port 2 of the UE.

### Predefined Antenna Port Association Relationship

In some examples, the UE may be predefined with an antenna port association relationship; for example, the UE may be predefined with an antenna port association relationship at factory settings; and the antenna port association relationship may associate the antenna ports of the UE with the uplink reference signal ports corresponding to the uplink reference signal resources. Moreover, after receiving the configuration information, the UE may associate the antenna ports used to transmit the uplink reference signals with the uplink reference signal ports corresponding to the uplink reference signal resources in the configuration information based on the predefined antenna port association relationship, and transmit the uplink reference signals on different resources based on the association relationship. Through the above design, the UE may be predefined with a fixed order to associate the antenna ports with the uplink reference signal ports.

### Determine the Antenna Port Association Relationship Based on the Index

In some examples, the UE may associate the antenna ports thereof with the uplink reference signal ports in sequence according to the association relationship included in the configuration information. The association relationship included in the configuration information is an index set of antenna ports; each index in the index set is used to identify a different antenna port of the UE; and the index is associated with a different reference signal port. The index of the antenna port is a universal representation, or may also be an identity, ID, etc. of the antenna port. Wherein, the index is reported by the UE; or the index is configured by the base station for the antenna port of the UE; and each index is associated with a different antenna port of the UE. Wherein, the index set may be represented by a bit sequence, consisting of no less than one subsequence; each index is represented by a subsequence; each subsequence has a same length, and each subsequence indexes an antenna port of the UE. Optionally, the association relationship between the UE antenna port and the index subsequence may be determined by the UE itself, and the UE needs to ensure that the association relationship does not change in the same cell. Optionally, the association relationship between the UE antenna port and the index subsequence may be constant. The UE associates the antenna ports used to transmit the uplink reference signals with the uplink reference signal ports corresponding to the uplink reference signal resources according to the above-described association relationship, and transmits the uplink reference signals on different resources based on the association relationship. Taking that the UE supports a maximum of N antenna ports as an example, an index subsequence of each antenna port is represented by an M-bit sequence, and it is ensured that the M-bit sequence may represent at least N different antenna port indices by configuring 2M>=N. Therefore, the configuration information received by the UE is an antenna port association relationship represented by a Y×M-bit sequence, where, ε_{y} is an index subsequence of an antenna port, Y represents the number of antenna switching ports supported by the configuration and satisfies Y∈N; and the UE associates the antenna ports thereof with the uplink reference signal ports in the order of the sequence. Through the above design, the UE may associate the antenna ports with the uplink reference signal ports in a certain order.

### Determine the Antenna Port Association Relationship According to the Order of Symbols Corresponding to the Reference Signal Ports

In some examples, the UE may read the predefined antenna port association relationship according to the configuration information. The predefined antenna port association relationship may be stored in the cache. Wherein, the UE obtains the total number of antenna switching ports supported by the uplink reference signal resource set through configuration information. Wherein, the antenna port association relationship stored by the UE in the cache is a sequence of antenna port association relationships generated by the UE itself; and the sequence is an ordering of all antenna ports of the UE. When the UE receives the configuration information including antenna switching, the UE reads the sequence of antenna port association relationships from the cache and associates with the uplink reference signal ports in sequence according to the order of symbols corresponding to the ordered reference signal ports of the antenna ports provided by the sequence. When the total number of antenna switching ports indicated in the configuration information is less than a length of the read sequence (i.e. the maximum number of antenna ports supported by the first node), the UE associates the antenna ports with the uplink reference signal ports in the order provided by the sequence; antenna ports ordered after the total number of antenna switching ports indicated in the configuration information in the sequence will not be associated, so the UE will not transmit uplink reference signals on these antenna ports. The UE associates the antenna ports used to transmit the uplink reference signals with the uplink reference signal ports corresponding to the uplink reference signal resources according to the above-described association order, and transmits the uplink reference signal on different resources based on the association relationship. Taking that the UE may support a maximum of Y antenna ports as an example, the sequence of the antenna switching order generated by the UE is S_{Y}={ε₁, ε₂, ε₃, . . . , ε_{y}} (ε_{y} represents a y-th antenna port of the UE); if the configuration information received by the UE indicates that the antenna switching method is xTy₁R, then the UE performs antenna switchings in the order of {ε₁, ε₂, ε₃, . . . , ε_{y}_{₁}}, where, y₁≤Y. Through the above design, the UE may associate the antenna ports with the uplink reference signal ports in a certain order.

### Updatable Antenna Port Association Relationship

In some examples, the UE may read the corresponding antenna port association relationship from the cache according to the configuration information. Wherein, the UE obtains the total number of antenna switching ports supported by the uplink reference signal resource sets and an antenna port association sequence update flag through the configuration information. The update flag indicates whether the UE updates the antenna port association relationship stored in the cache. When the update flag is positive, the UE generates a sequence of antenna port association relationships according to the total number of antenna switching ports indicated by the configuration information and stores the same in the cache, and associates the antenna ports thereof with the uplink reference signal ports according to the newly generated sequence order. When the update flag is negative, the UE reads the sequence of antenna port association relationships from the cache, and associates the antenna ports thereof with the uplink reference signal ports in sequence according to the order provided by the sequence. The process of the UE reading the sequence of antenna port association relationships from the cache and performing antenna switching is as follows: 1) if the total number of antenna switching ports indicated by the configuration information is equal to the sequence length of the antenna port association relationships extracted from the cache, then the read association order is directly used to associate the antenna ports with the uplink reference signal ports (e.g., if the UE is configured antenna switching performing xTyR, and the sequence length of the association relationships extracted from the cache is also y, then the order provided by the sequence is directly used to perform antenna association); 2) if the total number of antenna switching ports indicated by the configuration information is greater than the sequence length of the antenna port association relationships read in the cache, firstly, the read order is used to perform antenna association, and then an antenna port association order is generated for other antenna ports to complete association (e.g., if the sequence length y2 of the antenna port association relationship extracted from the cache is less than the total number of antenna switching ports y1 indicated by the configuration information, then the UE firstly performs y2 rounds of antenna port association according to the order extracted from the cache, and then performs y1−y2 rounds of antenna port association according to the order generated by the UE itself); and 3) if the total number of antenna switching ports indicated by the configuration information is less than the sequence length of the antenna port association relationships read in the cache, the UE performs antenna association according to the antenna port association relationship corresponding to the sequence, and antenna ports ordered after the total number of antenna switching ports indicated by the configuration information in the sequence will not be associated with the uplink reference signal ports, so the UE will not transmit uplink reference signals on these antenna ports (e.g., if the sequence length y2 of the antenna port association relationships read from the cache is greater than the number of antenna switching y1 indicated by the configuration information, then the UE will firstly associate the first y1 antenna ports according to the order extracted from the cache with the uplink reference signal ports). The UE associates the antenna ports used to transmit the uplink reference signals with the uplink reference signal ports corresponding to the uplink reference signal resources according to the above-described association order, and transmits the uplink reference signals on different resources based on the association relationship. Through the above design, the UE may associate the antenna ports with the uplink reference signal ports in a certain order, and update the antenna port association sequence according to indication of the base station.

### Antenna Port Association Order Read According to Index

In some examples, the UE may read the corresponding antenna port association relationship from the cache according to the configuration information. Wherein, the UE obtains the total number of antenna switching ports supported by the uplink reference signal resource sets and the antenna port association relationship sequence index through the configuration information. Exemplarily, the UE may store no less than one antenna port association relationship sequences in the cache, and obtain the antenna port association relationship sequence corresponding to the current uplink reference signal resource set through the antenna port association relationship sequence index. When the sequence indicated by the antenna port association relationship sequence index does not exist, the UE generates a sequence of antenna port association relationship according to the total number of antenna switching ports indicated by the configuration information and stores the same in the cache, and associates the antenna ports thereof with the uplink reference signal ports according to the order of the newly generated sequence. When the UE successfully reads the sequence indicated by the antenna port association relationship sequence index from the cache, the UE associates the antenna ports thereof with the uplink reference signal ports in sequence according to the order provided by the sequence. The process of the UE reading the sequence of antenna port association relationship from the cache and performing antenna switching is as follows: 1) if the total number of antenna switching ports indicated by the configuration information is equal to the sequence length of the antenna port association relationship extracted from the cache, the read association relationship are directly used to associate the antenna ports with the uplink reference signal ports; 2) if the total number of antenna switching ports indicated by the configuration information is greater than the sequence length of the antenna port association relationship read in the cache, the read order is firstly used to perform antenna association, and then an antenna port association relationship is generated for other antenna ports to complete association; and 3) if the total number of antenna switching ports indicated by the configuration information is less than the sequence length of the antenna port association relationship read in the cache, the UE performs antenna association according to the antenna port association order corresponding to the sequence, and antenna ports ordered after the total number of antenna switching ports indicated by the configuration information in the sequence will not be associated with the uplink reference signal ports, so the UE will not transmit uplink reference signals on these antenna ports. The UE associates the antenna ports used to transmit the uplink reference signals with the uplink reference signal ports corresponding to the uplink reference signal resources according to the above-described association relationship, and transmits the uplink reference signals on different resources based on the association relationship. Through the above design, the UE may associate the antenna ports with the uplink reference signal ports in the order provided by the indicated sequence, according to the indication of the base station.

### Antenna Port Association Relationship Based on Uplink Reference Signal Resource Set Identity (ID)

In some examples, the configuration information received by the UE for the first reference signal resource set includes an identity of the second reference signal resource set. The identity described here is a universal name, which may also be identification, ID, etc. Based on the association relationship between a plurality of antenna ports in the second reference signal resource set corresponding to the ID included in the configuration information and a plurality of reference signal ports, the UE determines the association relationship between the reference signal ports included in the first reference signal resource set and the antenna ports of the UE. The UE corresponds the plurality of antenna ports to the plurality of reference signal ports according to the obtained association relationship. For example, the configuration information received by the UE is the first reference signal resource set, which includes the ID of the second reference signal resource set. Through the ID, the UE obtains that the reference signal ports 300x1 and 300x2 of the second reference signal resource set respectively corresponds the same to the antenna port 1 and the antenna port 2 of the UE. Based on this, the UE also respectively corresponds the reference signal ports 300x1 and 300x2 in the first reference signal resource set to the antenna port 1 and the antenna port 2 of the UE.

Through the above-described example embodiment, the UE may obtain the association relationship between the uplink reference signal resources transmitting SRS and the antenna ports according to the configuration information, and perform SRS antenna switching in sequence through the association relationship. Through the above-described functions, the base station may obtain the association relationship between the SRS resources and the antenna ports used by the user to transmit SRS, so as to implement inference and adaptive structure adjustment of the neural network for obtaining uplink CSI.

In addition, according to the embodiment of the present disclosure, a same UE may be simultaneously configured with a variety of different antenna switching methods for uplink reference signal transmission for antenna switching purposes; by receiving SRS of different antenna switching configurations, the neural network at the base station may simultaneously perform inference and adaptive structure adjustment, so that the neural network at the base station may implement efficient adaptive structure adjustment, which, thus, increases accuracy of CSI acquisition and reduces inference latency and computational resource overhead of the neural network. Hereinafter, an example embodiment of configuring a variety of different antenna switching methods for the same UE and determining the antenna port association relationships for different antenna switching methods will be described.

### Indicate the Antenna Switching Method, Associate Based on a Variety of Antenna Switching Methods, and Determine the Antenna Port Association Relationship

In some examples, the configuration information received by the UE may include antenna switching method indication and antenna switching method association indication; the antenna switching method indication is used to indicate the antenna switching method corresponding to the current resource set (represented by a first antenna switching method); the antenna switching method association indication is used to indicate the antenna port association relationship of the second antenna switching method associated with the current resource set (the first antenna switching method); and the UE may obtain the antenna port association relationship for the first antenna switching method according to the antenna switching method association indication in the configuration.

In some examples, the “antenna switching method indication” may be a length-fixed binary bit sequence; each representation of the sequence represents an antenna switching method; the length of the sequence is associated with the maximum number that can be represented; and the maximum number that can be represented by the sequence should be greater than the number of antenna switching methods that can be supported by the UE. Taking that the configuration information received by the UE includes two uplink reference signal resource sets respectively configured with antenna switching methods of 1T4R and 1T2R as an example, the UE utilizes the resources configured by the first uplink reference signal resource unit to perform antenna switching of 1T4R, and the UE simultaneously utilizes the resources configured by the second uplink reference signal resource unit to perform antenna switching of 1T2R. Through the above design, the UE may determine the antenna switching method of the resource set according to an antenna switching method indication included in each uplink reference signal resource set, and use the antenna switching method to transmit the uplink reference signal. Therefore, the UE may be simultaneously configured with no less than two uplink reference signal resource sets that respectively support different antenna switching methods, so that the UE may simultaneously support uplink reference signal transmission of no less than two different antenna switching methods.

In some examples, the UE may read the antenna port association relationship corresponding to the first antenna switching method from the cache, taking the antenna switching method association indication in the configuration information as an index. When UE takes the antenna switching method association indication as an index, and the antenna port association order of the first antenna switching method read from the cache does not exist, the UE generates a sequence of antenna port association relationship according to the first antenna switching method related configuration and stores the same in the cache, and associates the antenna ports thereof with the uplink reference signal ports according to the newly generated sequence order. When the UE takes the antenna switching method association indication as an index, and successfully reads the sequence of antenna port association relationship from the cache, the UE associates the antenna ports thereof with the uplink reference signal ports in sequence according to the order provided by the sequence. The process of the UE reading the sequence of the antenna port association relationship from the cache and performing antenna switching is as follows: 1) if the total number of antenna switching ports indicated by the configuration information is equal to the sequence length of the antenna port association relationship extracted from the cache, then the read association order is directly used to associate the antenna ports with the uplink reference signal ports; 2) if the total number of antenna switching ports indicated by the configuration information is greater than the sequence length of the antenna port association relationship read in the cache, firstly, the read order is used to perform antenna association, and then an antenna port association order is generated for other antenna ports to complete association; 3) if the total number of antenna switching ports indicated by the configuration information is less than the sequence length of the antenna port association relationship read in the cache, the UE performs antenna association according to the antenna port association order corresponding to the sequence, and antenna ports ordered after the total number of antenna switching ports indicated by the configuration information in the sequence will not be associated with the uplink reference signal ports, so the UE will not transmit uplink reference signals on these antenna ports. The UE associates the antenna ports used to transmit the uplink reference signals with the uplink reference signal ports corresponding to the uplink reference signal resources according to the above-described association relationship, and transmits the uplink reference signals on different resources based on the association relationship. Through the above design, the UE may associate the uplink reference signal resource sets corresponding to different antenna switching methods with the antenna ports and the uplink reference signal ports in the same order.

### Indicate the Antenna Switching Process, Associate Based on a Variety of Antenna Switching Processes, and Determine the Antenna Port Association Relationship

In some examples, the configuration information received by the UE may include an antenna switching process number and an antenna switching process association indication. Wherein, the antenna switching process represents a process of enabling the base station to obtain all channel information of all antenna ports of a certain UE; an antenna switching process needs to be implemented by resources configured by no less than one uplink reference signal resource sets; the uplink reference signal resource sets used to perform the same antenna switching process are configured with the same antenna switching process number; and different antenna switching processes may be configured with different or identical antenna switching methods. Wherein, the antenna switching process association indication is used to indicate the antenna port association relationship of the second antenna switching process associated with the current resource set (using the first antenna switching process); and the UE may obtain the antenna port association relationship for the first antenna switching process according to the antenna switching process association indication in the configuration information.

In some examples, the UE may determine the antenna switching process to which the resource set belongs according to the antenna switching process number included in the configuration information; the uplink reference signal ports corresponding to the uplink reference signal resources included in all uplink reference signal resource sets configured with the same antenna switching process are associated with different user antenna ports. Taking that configuration signaling received by the UE includes three uplink reference signal resource sets as an example, it is assumed that the antenna switching process number configured for the first two resource sets is 1, the antenna switching process number configured for the third resource set is 2, and each resource set is configured with resources performing the 1T2R antenna switching method. The first and second resource sets belong to a same antenna switching process, so the UE utilizes the resources configured by these two resource sets to perform 1T4R antenna switching. Meanwhile, the UE utilizes the resources configured by the third resource set to perform 1T2R antenna switching. Through the above design, the UE may be simultaneously configured with no less than two uplink reference signal resource sets that support different antenna switching processes; and different antenna switching processes may be associated with different antenna switching methods, so that the UE may simultaneously support uplink reference signal transmission of no less than one different antenna switching method.

In some examples, the UE may take the antenna switching process association indication in the configuration information as an index, and read the corresponding antenna port association relationship from the cache. Exemplarily, when the UE takes the antenna switching process association indication as an index, and the antenna port association order of the second antenna switching process read from the cache does not exist, the UE generates a sequence of antenna port association relationship according to the first antenna switching process related configuration and stores the same in the cache, and associates the antenna ports thereof with the uplink reference signal ports according to the newly generated sequence order. When the UE takes the antenna switching process association indication as an index and successfully reads the antenna port association relationship from the cache, the UE associates the antenna ports thereof with the uplink reference signal ports in sequence according to the order provided by the sequence. The process of the UE reading the sequence of the antenna port association order from the cache and performing antenna switching is as follows: 1) if the total number of antenna switching ports indicated by the configuration information is equal to the sequence length of the antenna port association relationship extracted from the cache, the read association relationship are directly used to associate the antenna ports with the uplink reference signal ports; 2) if the total number of antenna switching ports indicated by the configuration information is greater than the sequence length of the antenna port association relationship read in the cache, the read order is firstly used to perform antenna association, and then an antenna port association relationship is generated for other antenna ports to complete association; and 3) if the total number of antenna switching ports indicated by the configuration information is less than the sequence length of the antenna port association relationship read in the cache, the UE performs antenna association according to the antenna port association relationship corresponding to the sequence, and antenna ports ordered after the total number of antenna switching ports indicated by the configuration information in the sequence will not be associated with the uplink reference signal ports, so the UE will not transmit uplink reference signals on these antenna ports. The UE associates the antenna ports used to transmit the uplink reference signal with the uplink reference signal ports corresponding to the uplink reference signal resources according to the above-described association order, and transmits the uplink reference signal on different resources based on the association relationship. Through the above design, the UE may associate the uplink reference signal resource sets corresponding to different antenna switching processes with the antenna ports and the uplink reference signal ports in the same order.

FIG. 9 illustrates a block diagram of a structure of a first node for transmitting a reference signal according to an embodiment of the present disclosure.

Referring to FIG. 9, the first node 900 includes a transceiver 910 and a controller 920. The transceiver 910 is configured to transmit a signal to and receive a signal from the outside. The controller 920 is configured to control the transceiver to transmit/receive a physical signal, and execute the reference signal transmitting method described in the present disclosure. The first node 900 may be implemented in a form of hardware, software, or a combination thereof, so that it can perform all the methods described in the present disclosure.

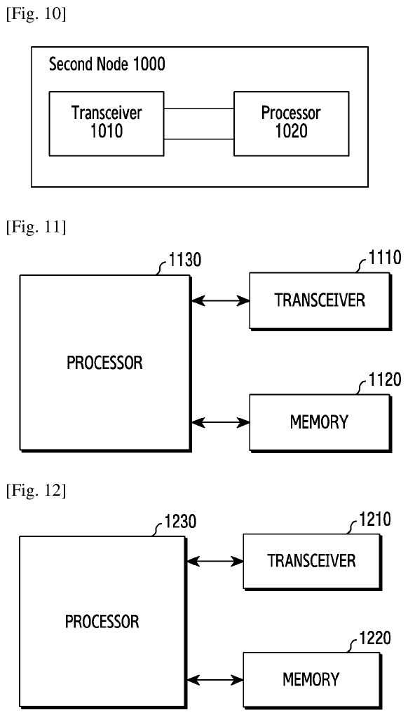

FIG. 10 illustrates a block diagram of a structure of a second node for receiving a reference signal according to an embodiment of the present disclosure.

Referring to FIG. 10, the first node 1000 includes a transceiver 1010 and a controller 1020. The transceiver 1010 is configured to transmit a signal to and receive a signal from the outside. The controller 1020 is configured to control the transceiver to transmit/receive a physical signal, and execute the reference signal receiving method described in the present disclosure. The first node 1000 may be implemented in a form of hardware, software, or a combination thereof, so that it can perform all the methods described in the present disclosure.

According to the embodiments of the present disclosure, the above first node and second node may be any communication nodes in a communication network, such as a base station, a terminal (UE) and the like.

FIG. 11 illustrates a block diagram illustrating a structure of a UE according to various embodiments of the present disclosure. FIG. 11 corresponds to the example of the UE of FIG. 3a.

As shown in FIG. 11, the UE according to an embodiment may include a transceiver 1110, a memory 1120, and a processor (e.g. controller) 1130. The transceiver 1110, the memory 1120, and the processor 1130 of the UE may operate according to a communication method of the UE described above. However, the components of the UE are not limited thereto. For example, the UE may include more or fewer components than those described above. In addition, the processor 1130, the transceiver 1110, and the memory 1120 may be implemented as a single chip. Also, the processor 1130 may include at least one processor.

The transceiver 1110 collectively refers to a UE receiver and a UE transmitter, and may transmit/receive a signal to/from a base station. The signal transmitted or received to or from the base station may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the UE. Also, the memory 1120 may store control information or data included in a signal obtained by the UE. The memory 1120 may be a storage medium, such as read-only memory (ROM), random access memory (RAM), a hard disk, a CD-ROM, and a DVD, or a combination of storage media.

The processor 1130 may control a series of processes such that the UE operates as described above. For example, the transceiver 1110 may receive a data signal including a control signal transmitted by the base station, and the processor 1130 may determine a result of receiving the control signal and the data signal transmitted by the base station. FIG. 12 illustrates a block diagram illustrating a structure of a base station according to various embodiments of the present disclosure. FIG. 12 corresponds to the example of the gNB of FIG. 3b.

As shown in FIG. 12, the base station according to an embodiment may include a transceiver 1210, a memory 1220, and a processor (e.g. controller) 1230. The transceiver 1210, the memory 1220, and the processor 1230 of the base station may operate according to a communication method of the base station described above. However, the components of the network entity are not limited thereto. For example, the base station may include more or fewer components than those described above. In addition, the processor 1230, the transceiver 1210, and the memory 1220 may be implemented as a single chip. Also, the processor 1230 may include at least one processor.

The transceiver 1210 collectively refers to a base station receiver and a base station transmitter, and may transmit/receive a signal to/from a terminal. The signal transmitted or received to or from the terminal may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the base station. Also, the memory 1220 may store control information or data included in a signal obtained by the base station. The memory 1220 may be a storage medium, such as read-only memory (ROM), random access memory (RAM), a hard disk, a CD-ROM, and a DVD, or a combination of storage media.

The processor 1230 may control a series of processes such that the network entity operates as described above. For example, the transceiver 1210 may receive a data signal including a control signal transmitted by the terminal, and the processor 1230 may determine a result of receiving the control signal and the data signal transmitted by the terminal.

The present disclosure aims to design a method for transmitting and receiving a reference signal, so that an association relationship between a reference signal resource for transmitting the reference signal and an antenna port can be obtained according to configuration information, and antenna switching is performed in sequence according to the association relationship. Through the above function, the communication node can obtain the association relationship between the reference signal resource and the antenna port for transmitting the reference signal, so as to implement inference and adaptive structure adjustment of the neural network for obtaining CSI. In the process of obtaining the CSI, the neural network can be used for inference, and the CSI of other antenna ports that have not transmitted reference signals can be inferred from the CSI of some antenna ports that have transmitted reference signals, so it is only necessary to transmit reference signals on some antenna ports to support obtaining the CSI of all antenna ports, such that the number of reference signal resources configured can be reduced to save resource overhead. At the same time, the number of times to perform antenna switching will be correspondingly reduced as the number of reference signal resources configured decreases. Meanwhile, according to the embodiments of the present disclosure, a variety of different antenna switching methods can be configured at the same time for reference signal transmission for antenna switching purposes, and by receiving reference signals of different antenna switching configurations, the neural network can perform inference and adaptive structure adjustment at the same time, so as to achieve efficient adaptive structure adjustment, thereby increasing accuracy of CSI acquisition and reducing latency and computing resource overhead of neural network inference.

Various embodiments of the present disclosure can be implemented as computer-readable codes embodied on a computer-readable recording medium from a specific perspective. The computer-readable recording medium is any data storage device that can store data readable by a computer system. Examples of the computer-readable recording medium may include read only memory (ROM), random access memory (RAM), compact disk read only memory (CD-ROM), magnetic tape, floppy disk, optical data storage device, carrier (e.g., data transmission through the Internet) and so on. The computer-readable recording medium can be distributed over computer systems connected via a network, and thus the computer-readable codes can be stored and executed in a distributed manner. Also, functional programs, codes, and code segments for implementing various embodiments of the present disclosure can be easily construed by those skilled in the art to which the embodiments of the present disclosure are applied.

It will be appreciated that embodiments of the present disclosure may be implemented in the form of hardware, software, or a combination thereof. The software may be stored as program instructions or computer-readable codes executable on a processor on a non-transitory computer-readable medium. Examples of the non-transitory computer-readable recording medium include magnetic storage media (e.g., ROM, floppy disk, hard disk, etc.) and optical recording media (e.g., CD-ROM, digital video disk (DVD), etc.). The non-transitory computer-readable recording medium can also be distributed over network coupled computer systems so that the computer-readable codes are stored and executed in a distributed manner. The media can be read by a computer, stored in a memory, and executed by a processor. Various embodiments can be realized by a computer or a portable terminal including a controller and a memory, and the memory may be an example of a non-transitory computer-readable recording medium suitable for storing program(s) having instructions implementing the embodiments of the present disclosure. The present disclosure can be implemented by a program having codes for embodying the means and methods described in the claims, the program being stored on a machine (or computer) readable storage medium. The program may be electronically carried on any medium such as a communication signal delivered via a wired or wireless connection, and the present disclosure suitably includes its equivalents.

The above description is only a specific implementation of the present disclosure, but the scope of protection of the present disclosure is not limited thereto. Any person skilled in the art can make various changes or replacements within the technical scope of the present disclosure. All these changes or replacements should fall within the protection scope of the present disclosure. Therefore, the protection scope of the present disclosure should be determined by the protection scope of the claims.

1. A method performed by a user equipment (UE) in a wireless communication system, the method comprising:
receiving, from a base station, configuration information for reference signals;
determining an association relationship between a plurality of antenna ports of the UE and a plurality of reference signal ports indicated in the configuration information; and
transmitting, to the base station, the reference signals via the plurality of antenna ports corresponding to the plurality of reference signal ports based on the association relationship,
wherein, the association relationship indicates that a reference signal port indicated by the configuration information corresponds to an antenna port of the UE.

2. The method of claim 1,
wherein the antenna port of the UE is associated with the reference signal port indicated in the configuration information, and
wherein the association relationship between the plurality of the antenna ports and the plurality of the reference signal ports are kept consistent in a same cell.

3. The method of claim 1, wherein:
the configuration information includes an index set;
an index in the index set is used for identifying the antenna port of the UE;
the index is associated with the reference signal port; and
the index is reported by the UE or is configured by the base station for the antenna port of the UE.

4. The method of claim 1, wherein the association relationship is determined based on an order of the plurality of antenna ports of the UE and an order of symbols corresponding to the reference signal ports.

5. A method performed by a base station in a wireless communication system, the method comprising:
transmitting, to a user equipment (UE), configuration information for reference signals;
determining an association relationship between a plurality of antenna ports of a first node and a plurality of reference signal ports indicated in the configuration information;
receiving, from the UE, the reference signals via the plurality of antenna ports corresponding to the plurality of reference signal ports based on the association relationship,
wherein, the association relationship indicates that a reference signal port indicated by the configuration information corresponds to an antenna port of the UE.

6. The method of claim 5,
wherein the antenna port of the UE is associated with the reference signal port indicated in the configuration information, and
wherein the association relationship between the plurality of the antenna ports and the plurality of the reference signal ports are kept consistent in a same cell.

7. The method of claim 5, wherein:
the configuration information includes an index set;
an index in the index set is used for identifying the antenna port of the UE;
the index is associated with the reference signal port; and
the index is reported by the UE or is configured by the base station for the antenna port of the UE.

8. The method of claim 5, wherein the association relationship is determined based on an order of the plurality of antenna ports of the UE and an order of symbols corresponding to the reference signal ports.

9. A user equipment (UE) in a wireless communication system, the UE comprising:
a transceiver; and
a controller coupled to the transceiver, and configured to:
receive, from a base station, configuration information for reference signals,
determine an association relationship between a plurality of antenna ports of the UE and a plurality of reference signal ports indicated in the configuration information, and
transmit, to the base station, the reference signals via the plurality of antenna ports corresponding to the plurality of reference signal ports based on the association relationship,
wherein, the association relationship indicates that a reference signal port indicated by the configuration information corresponds to an antenna port of the UE.

10. The UE of claim 9,
wherein the antenna port of the UE is associated with the reference signal port indicated in the configuration information, and
wherein the association relationship between the plurality of the antenna ports and the plurality of the reference signal ports are kept consistent in a same cell.

11. The UE of claim 9, wherein:
the configuration information includes an index set;
an index in the index set is used for identifying the antenna port of the UE;
the index is associated with the reference signal port; and
the index is reported by the UE or is configured by the base station for the antenna port of the UE.

12. The UE of claim 9, wherein the association relationship is determined based on an order of the plurality of antenna ports of the UE and an order of symbols corresponding to the reference signal ports.

13. A base station in a wireless communication system, the base station comprising:
a transceiver; and
a controller coupled to the transceiver, and configured to:
transmit, to a user equipment (UE), configuration information for reference signals,
determine an association relationship between a plurality of antenna ports of a first node and a plurality of reference signal ports indicated in the configuration information,
receive, from the UE, the reference signals via the plurality of antenna ports corresponding to the plurality of reference signal ports based on the association relationship,
wherein, the association relationship indicates that a reference signal port indicated by the configuration information corresponds to an antenna port of the UE.

14. The base station of claim 13,
wherein the antenna port of the UE is associated with the reference signal port indicated in the configuration information, and
wherein the association relationship between the plurality of the antenna ports and the plurality of the reference signal ports are kept consistent in a same cell.

15. The base station of claim 13, wherein:
the configuration information includes an index set;
an index in the index set is used for identifying the antenna port of the UE;
the index is associated with the reference signal port; and
the index is reported by the UE or is configured by the base station for the antenna port of the UE.
